(19) United States
(12) Patent Application Publication
(10) Pub. No.: US 2023/0265603 A1
(43) Pub. Date: Aug. 24, 2023

(54) INSTALLING SHADE FABRIC TO TUBE

(71) Applicant: Barry J. Cullinane, St Augustine, FL (US)

(72) Inventor: Barry J. Cullinane, St Augustine, FL (US)

(21) Appl. No.: 17/676,482

(22) Filed: Feb. 21, 2022

(51) Int. Cl. D06H 3/00; E04F 10/06; E06B 9/44; D06H 7/02

(52) U.S. Cl. CPC D06H 3/00; E04F 10/06; E06B 9/44; D06H 7/02

(57) ABSTRACT

Various implementations disclosed herein include devices, systems, and methods for installing a shade fabric having a first edge portion to a tube. A deflection curve of the tube is determined. The first edge portion of the shade fabric is cut in accordance with the deflection curve of the tube. The shade fabric is attached to the tube at the first edge portion of the shade fabric.

### CROSS-REFERENCE TO RELATED APPLICATIONS

This application claims the benefit of U.S. Provisional Application 63/152,239 filed on Feb. 22, 2021, the contents of which are hereby incorporated by reference in its entirety.

### TECHNICAL FIELD

The present disclosure generally relates to assembly of roller shades.

### BACKGROUND

Roller shades and retractable awnings are popular styles of window treatments that typically include a sheet of material (e.g., fabric) that covers the length of a window when in use. The fabric is rolled over a supporting tube, e.g., using a cord, chain, crank, or a cordless (e.g., motorized) lift system, when it is desired to uncover the window. In many cases, roller shades and retractable awning systems are only supported at their end portions. Gravity and fabric tension (e.g., the weight of the fabric) can lead to deflection near the center portion of the tube (e.g., near the midspan of the tube), and the fabric near the midspan may not be supported properly. The center portion of the tube may be lower than the end portions by a distance equal to the maximum tube deflection. As a result, fabric tension may decrease toward the center portion of the fabric. This may be perceived as a visual anomaly in the fabric, such as fullness, a “smile,” and/or a V-shaped artifact in the fabric. Visual anomalies may be aesthetically undesirable, e.g., in projection screen applications. In some cases, ripples may occur when the fabric is rolled up on the tube. Such rippling can permanently imprint the fabric with unsightly patterns.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a diagram illustrating marking an inverted deflection curve onto a tube according to various implementations.

FIG. 2 is a diagram illustrating an example shade system including a fabric and a tube according to various implementations.

FIG. 3 is a diagram illustrating an example shade system modelled as a simply supported beam with a uniformly distributed load.

FIG. 4 is a diagram illustrating an example shade system modelled as a simply supported beam with an applied point load.

FIG. 5 is a diagram illustrating an example roller shade system.

FIG. 6 is a diagram illustrating an example roller shade system according to various implementations.

FIG. 7 is a diagram illustrating an example method of cutting the deflection curve directly into a fabric top edge according to various implementations.

In accordance with customary practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein may include devices, systems, and methods for installing shade fabric to a tube, e.g., for roller shade applications. In some implementations, a method determining a deflection curve of the tube. A first edge portion of the shade fabric is cut in accordance with the deflection curve of the tube. The shade fabric is attached to the tube at the first edge portion of the shade fabric.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, and devices have not been described in exhaustive detail so as not to obscure more pertinent aspects of the example implementations described herein.

In window treatment systems in which a shade fabric is supported on a tube that is, in turn, supported only on its ends, deflection in the tube midspan is related to tube stiffness, fabric weight, and the span of the tube. When fabric fullness is an issue, in some implementations, a stiffer tube is used. Stiffening the tube may involve increasing the diameter of the tube and/or using a stiffer tube material. These approaches may result in installing a larger and/or heavier roller shade system. As a result, resource usage and associated costs may be increased. Further, the window treatment system may be more noticeable and may detract from the overall aesthetic appearance of the window opening.

In some implementations, the span of the fabric is divided into multiple smaller panels. However, this approach introduces potentially undesirable light gaps between each fabric panel. Such light gaps may be particularly undesirable in the case of room darkening window treatments, e.g., blackout panels.

Certain under-tube support systems support the rotating fabric roll from under the roll. However, such support systems tend to be complex and expensive.

In some implementations, the tube is stiffened internally. For example, stiffening members may be employed within the tube. These approaches tend to increase complexity and usage of resources. In some implementations, multiple nested tubes are employed. These approaches tend to result in heavy support systems that have potentially large diameters.

According to various implementations disclosed herein, a material, e.g., a cut height of a shade fabric may be varied across a width of the fabric to promote even distribution of a weight of a hem bar across the width of the fabric. This reduces or eliminates the need to adjust the shade fabric after the shade fabric is hung on the test hoist.

Various implementations disclosed herein work with existing tube deflection to reduce the appearance of fullness in a window treatment system, such as a roller shade system or a retractable awning. As a result, a more aesthetically pleasing product may be realized relative to some conventional systems. Further, the range of size specifications of window treatment systems may be extended, e.g., wider fabric widths may be implemented.

Fullness in the shade fabric may be reduced by manually adjusting the shade fabric on the ends down on a test hoist to redistribute fabric tension. This may be done via a trial-and-error process that is performed with the shade fabric in a fully deployed state (e.g., installed or hung) on the test hoist (e.g., with adjustments needed at both ends). This process may be time-consuming and may require a high level of skill. Accordingly, manufacturers tend to avoid performing this process.

According to various disclosed implementations, a shade fabric is adjusted before hanging on the test hoist. The shade fabric may be adjusted in a systematic, repeatable manner that may be based on a target result that may be achievable. In some implementations, a tube deflection (e.g., a maximum tube deflection) is calculated theoretically. A deflection quantity (e.g., a deflection percentage) may be used to quantify an effect of deflection and/or may be used as a criterion to determine whether the stiffness of a tube is insufficient.

Table 1 discloses some example prefabrication specifications for an example roller shade system.

TABLE 1

| Calculations | — |
|---|---|
| Maximum hanging weight | 5.902 lb. (2.677 kg) |
| Maximum system weight | 11.362 lb. (5.154 kg) |
| Deflection | 0.062 |
| Deflection percentage | 0.069 |
| Rollup diameter | 2.026 inches (51.460 mm) |
| Maximum rollup diameter | 2.500 inches (63.500 mm) |
| Front roller drag | 2.184 inch-lb. (0.247 N-m) |
| Total system power | 6.630 W |
| Total torque required | 4.839 inch-lb. (0.547 N-m) |

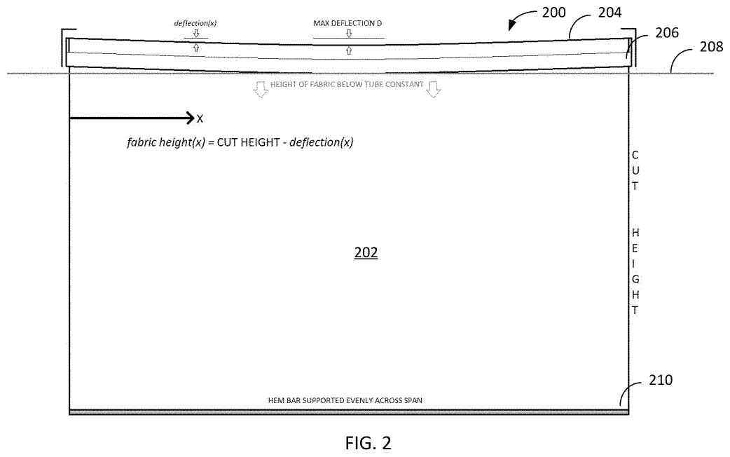

In some implementations, a curvature of the tube is determined theoretically. If a fabric cut height across a width of the fabric panel varies (i.e., is reduced along a top edge of the fabric panel) by the local tube deflection at multiple points along the tube (e.g., at every point on the tube), the height of fabric below a reference line (e.g., line 208 of FIG. 2) across the span of the tube, may remain constant. This promotes even distribution of the weight of the hem bar across the width of the shade fabric. A flatter fabric panel appearance may result. Other advantages may include more even fabric tension rolling up on the tube and/or achievement of increased (e.g., maximum) deflection percentage for a tube.

In some implementations, a top edge of the shade fabric is cut to match (e.g., within a threshold of or exactly) a theoretically determined deflection curve of the tube on a cutting table with two-dimensional cutting capabilities. This cut may be approximated using certain production floor techniques. For example, an inverted deflection curve may be marked on the tube, as disclosed herein. The straight top edge of the shade fabric may be attached to the tube at the inverted deflection curve. A cut may then be made parallel to the undeflected tube to produce the deflection curve in the top edge of the shade fabric.

In some implementations, a bare tube (e.g., a tube with no shade fabric attached) is flipped over (e.g., to an opposite drive side), and deflection is simulated by placing rolled-up fabric (e.g., the fabric panel that will be used) with a hem bar on top of the tube. The rolled-up fabric has stiffness that may result in the weight of the fabric not being evenly distributed across the span of the deflected tube. If the shade fabric is used to simulate hanging deflection, the fabric may be rolled up loosely with the hem bar lying flat for maximum deflection.

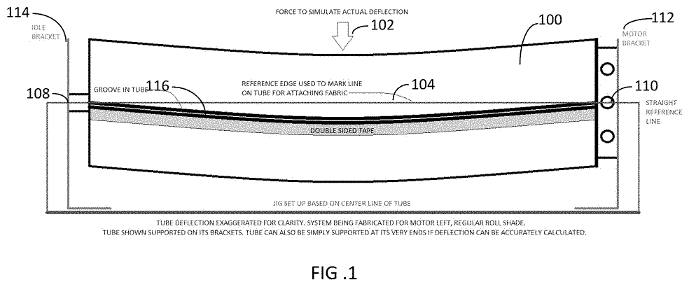

In some implementations, as represented in FIG. 1, tube deflection is approximated with the application of an additional load that is equivalent to the distributed weight of the intended fabric panel. In some implementations, the tube deflection is approximated by the application of an additional force 102 until the theoretically determined final deflection is generated. A jig that is designed with a straight reference edge 104, matching the undeflected center line of a tube 100, can be used to mark a straight line between vertical midpoints 108, 110 at each end of the tube 100.

As illustrated in FIG. 1, the tube 100 may be installed on hardware similar to hardware on which the tube 100 would be installed in a use case environment, e.g., a motor bracket 112 and an idle bracket 114. Installing the tube 100 on the motor bracket 112 and the idle bracket 114 may simulate real world end supports and the effect of the weight of the motor. In some implementations, simply supporting the tube 100 at its end portions may provide a sufficient curve approximation, e.g., without mounting the tube 100 on the motor bracket 112 and/or the idle bracket 114.

The degree of accuracy that is simulated may depend on the deflection percentage of the system that is being built. For example, a system characterized by a high deflection percentage may approximate the curve accurately, e.g., as accurately as possible. As another example, a system characterized by a lower deflection percentage may use a first approximation, e.g., using only the weight of the tube to simulate deflection, for example, without applying any fabric weight.

In some implementations, when the tube 100 is flipped back over and returned to an unloaded state, the marked line forms an inverted deflection curve upon which the straight-cut top edge of the fabric can be attached. Some adjustment, e.g., rolling the fabric up on a tighter diameter in the center, may be performed to assist with attaching the straight-cut top edge of the fabric to the slightly curved line.

In some implementations, the aforementioned processes of determining a deflection curve of the tube 100 and cutting a top edge of the fabric to match the deflection curve of the tube 100 may be performed in connection with an external groove 116 on the tube 100. The groove may be used as a straight guide. For example, the groove may be parallel to the tube 100 and may be used as a guide to cut away excess fabric in the center of the tube, effectively cutting the deflection curve into the top edge of the fabric. In some implementations, the fabric is rolled up loosely until the fabric can be hung on the test rack and rolled up under its own weight in the deflected state.

In some implementations, the excess fabric in the center of the tube may be left in place if it is not creating any roll up issues, or is cut away, e.g., if there are roll up issues. For example, the excess fabric may be cut away if the fabric tracks toward the center and/or if the hem bar bends up in the center near the upper limit.

FIG. 2 is a diagram illustrating an example shade system 200 including a fabric 202 and a tube 204. In some implementations, if a top edge 206 of the fabric 202 is cut to match a deflection curve of the tube 204, a length of fabric below a line 208 is a constant across the span of the fabric 202. Accordingly, a hem bar 210 is evenly supported, and a tension of the hem bar 210 is uniformly applied across the fabric 202.

In many cases, a significant portion of the tube deflection is attributable to the weight of the tube itself. A less significant portion of the tube deflection is attributable to the weight of the fabric. In some implementations, however, the distributed weight of the fabric is still accounted for to promote higher accuracy in determining the deflection curve of the tube. The actual fabric can be used to simulate deflection, but handling fabric can be problematic. Accordingly, it may be desirable to reduce or minimize handling of fabric.

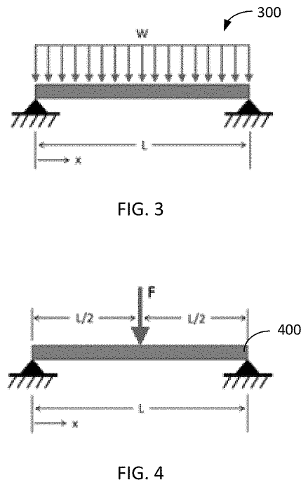

In some implementations, the fabric load is modeled as one or more point loads applied to the tube. As illustrated in FIG. 3, a roller shade system 300 closely approximates a simply supported beam with a uniformly distributed load. Deflection in this situation is determined using the formula:

$$\underline{Deflection}$$

$$δ = - \frac{wx}{24 EI} ( \text{?} )$$

$$\text{?} = \frac{5 w \text{?}}{384 EI} @ x = L / 2$$

$$\text{?} \text{indicates text missing or illegible when filed}$$

where the maximum deflection occurs at the midpoint of the tube, e.g., x=L/2.

In some implementations, the uniformly distributed load is approximated by the application of a point load applied to the center of a tube 400, as shown in FIG. 4. The point load may be equivalent to or substantially equivalent to ⅝ of the total (e.g., combined fabric and hem bar) distributed weight (wL). The total fabric panel weight may be determined based on a known fabric square yardage weight and a hem bar length. These quantities may be determined prior to manufacture to ensure that the system design is feasible. For example, if the combined weight of the fabric and the hem bar is 10 pounds, the maximum deflection may be closely approximated by a center point load of 6.25 pounds. Deflection in this situation can be determined using the formula:

$$\underline{Deflection}$$

$$δ = - \frac{Px}{\text{?} EI} \text{?} ( 0 \leq x \leq L / 2 )$$

$$\text{?} @ x = L / 2$$

$$\text{?} \text{indicates text missing or illegible when filed}$$

where the maximum deflection occurs at the midpoint of the tube, e.g., x=L/2.

In some implementations, deflection may be approximated by the application of approximately ⅜ of the combined fabric and hem bar weight at two points along the length of the tube, ⅓ of the way inward from each end of the tube. In some implementations, flexible, stackable weighted strips can be used to match the linear fabric and hem bar weight (e.g., 1-2 pounds per linear foot) and simulate a uniformly distributed load.

In addition to aesthetic concerns, excessive deflection can create tracking issues. Deflection can cause fabric tension to be greater toward the ends of the tube and less in the middle. When the fabric is rolled up, the looser fabric toward the middle of the tube may have a slightly larger roll up diameter than at the ends, causing the fabric on both ends to track toward the center.

As fabric from both ends of the tube works its way toward the center, the fabric may bunch up and form ripples on the tube. If this tendency is not corrected, these ripples can form permanent undesirable patterns on the fabric. A fabric length adjusted tension redistribution process may equalize the fabric tension across the span of the shade and create a more uniform roll up diameter across the span. This may reduce the tendency of the fabric to ripple.

In some implementations, removing excess fabric from the midspan, e.g., by straight cutting along the tube groove after fabric attachment, may further reduce the tendency for the fabric to track center. Excess fabric in the middle of the tube may effectively shim the center and may draw fabric inwards on roll up. Removing this excess fabric may further reduce this tendency.

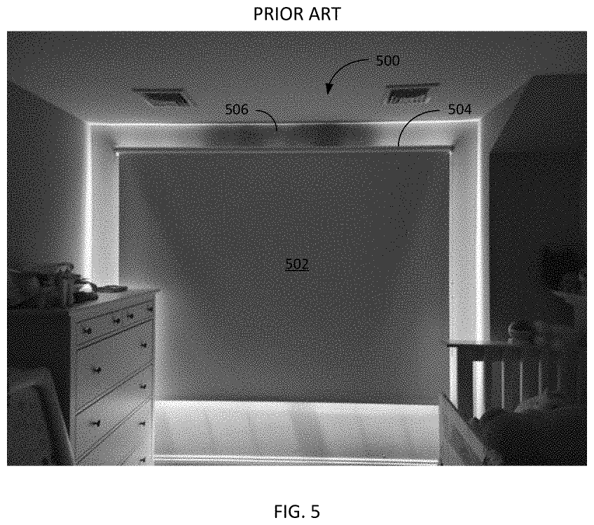

FIG. 5 is a diagram illustrating an example roller shade system 500. The roller shade system 500 includes a shade fabric 502 having dimensions of 91″ (width) by 70″ (height). The shade fabric 502 may be implemented, for example, as an opaque fabric. The shade fabric 502 may be supported on a tube 504, which may be implemented as a 1.625″ tube. Table 2 discloses some example prefabrication specifications for the roller shade system 500.

TABLE 2

| Calculations | — |
|---|---|
| Maximum hanging weight | 5.902 lb. (2.677 kg) |
| Maximum system weight | 11.362 lb. (5.154 kg) |
| Deflection | 0.062 |
| Deflection percentage | 0.069 |
| Rollup diameter | 2.026 inches (51.460 mm) |
| Maximum rollup diameter | 2.500 inches (63.500 mm) |
| Front roller drag | 2.184 inch-lb. (0.247 N-m) |
| Total system power | 6.630 W |
| Total torque required | 4.839 inch-lb. (0.547 N-m) |

FIG. 5 illustrates the shade system 500 fabricated under conventional production processes. Noticeable visual defects, such as the appearance of a “V” or a “smile” can be seen even at a deflection percentage of 0.07%. The maximum deflection percentage allowable for this example roller shade system may be 0.1%. Further, a significant shadow 506 is visible above the shade system 500 at the center where the shade fabric 502 is not tight to the tube 504. This area is an area of low fabric tension and is characterized by reduced clearance between the roll and the window trim.

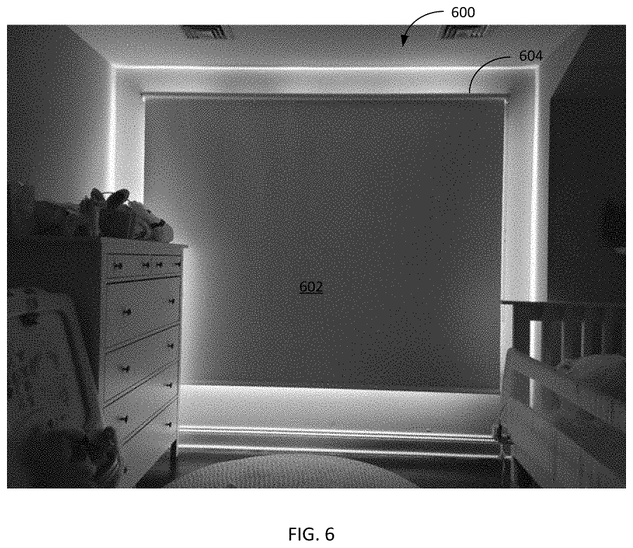

FIG. 6 is a diagram illustrating an example roller shade system 600. The roller shade system 600 includes a shade fabric 602 having dimensions of 91″ (width) by 70″ (height). The shade fabric 602 may be implemented, for example, as an opaque fabric. The shade fabric 602 may be supported on a tube 604, which may be implemented as a 1.625″ tube. Table 3 discloses some example prefabrication specifications for the roller shade system 600.

TABLE 3

| Calculations | — |
|---|---|
| Maximum hanging weight | 5.902 lb. (2.677 kg) |
| Maximum system weight | 11.362 lb. (5.154 kg) |
| Deflection | 0.062 |
| Deflection percentage | 0.069 |
| Rollup diameter | 2.026 inches (51.460 mm) |
| Maximum rollup diameter | 2.500 inches (63.500 mm) |
| Front roller drag | 2.184 inch-lb. (0.247 N-m) |
| Total system power | 6.630 W |
| Total torque required | 4.839 inch-lb. (0.547 N-m) |

FIG. 6 illustrates the shade system 600 with the fabric length of the shade fabric 602 adjusted and the tension redistributed as disclosed herein. In the shade system 600 illustrated in FIG. 6, length adjustment involved hanging approximately ⅝ of the fabric weight from the center of the flipped, bare tube to mimic deflection. A straight reference line was created using a taut string line. As represented in FIG. 6, the appearance of a “smile” is noticeably less than represented in FIG. 5. Further, no shadow is visible above the shade system 600 at the center because the fabric tension is relatively consistent with the fabric tension at other locations along the length of the tube 604. Accordingly, the clearance between the roll and the window trim is relatively uniform along the length of the tube 604.

In some implementations, the stiffness of the tube may vary based on the orientation of the tube due to the extrusion profile. Tube deflection may be determined and/or marked based on the tube orientation at the lower limit. Tube orientation may be determined based on the ordered system height of the shade system, the bracket vertical projection, and/or additional fabric wrap added. Extra fabric wrap may be adjusted to position the tube groove at the midway position for marking.

In some implementations, double sided tape may be used to affix the fabric to the tube. In some implementations, a spline is welded to the top edge of the fabric or inserted inside a welded pocket to mechanically engage with grooves in the roller tube to secure the fabric to the tube. The deflection curve may be cut into the top edge of the fabric before welding the top pocket or spline to the fabric.

In some implementations, low tack double sided tape may be used to affix the fabric to the tube so that the fabric can be removed from the tube easily after the deflection curve is cut into the top edge of the fabric. After the deflection curve is cut, the fabric moves to the welder so that the spline can be welded on the fabric, or the spline pocket can be welded. The fabric may be rolled up more tightly in the center to provide a straight top edge for welding purposes. The fabric may then be permanently attached to the tube.

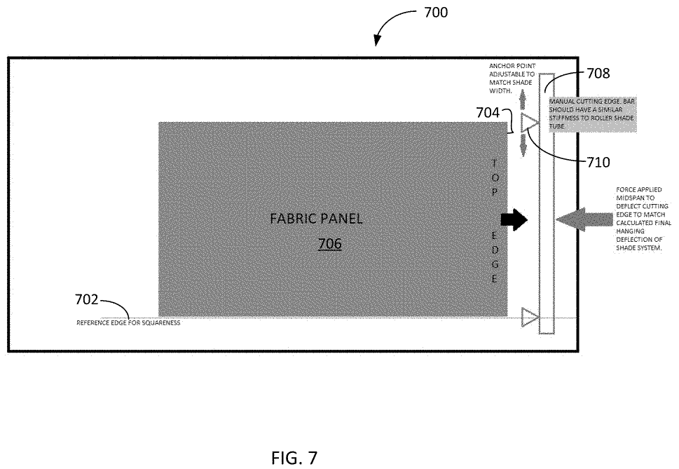

FIG. 7 is a diagram illustrating an example installation process for cutting the deflection curve directly into a top edge of a fabric panel of a shade system 700. In some implementations, a reference cutting edge 702 may be set up on a shade cutting table for manually cutting a curved top edge 704 of a fabric 706. A straight edge 708 may be laid on top of the top edge of the fabric panel. The reference cutting edge 702 is a physical guide that is arranged perpendicular to the straight edge 708 so that the top cut will be square to the sides. The straight edge 708 may be implemented as a bar having a similar stiffness to a roller shade tube. The straight edge 708 may be anchored at an anchor point 710, which may be adjustable to match the width of the shade. A force may be applied to the midspan of the straight edge 708 to deflect the straight edge 708 to match the calculated maximum deflection of the finished shade system. The deflection curve may be cut manually before the fabric is moved onto the welding machine for the spline or pocket.

What is claimed is:

1. A method for installing a shade fabric having a first edge portion to a tube, the method comprising:
determining a deflection curve of the tube;
cutting the first edge portion of the shade fabric in accordance with the deflection curve of the tube; and
attaching the shade fabric to the tube at the first edge portion of the shade fabric.

2. The method of claim 1, wherein cutting the first edge portion of the shade fabric in accordance with the deflection curve of the tube comprises:
marking an inverted deflection curve on the tube; and
attaching the first edge portion of the shade fabric to the tube at the inverted deflection curve.

3. The method of claim 1, wherein determining the deflection curve of the tube comprises determining a deflection of the tube as a function of a weight of the tube.

4. The method of claim 1, wherein determining the deflection curve of the tube comprises determining a deflection of the tube as a function of a weight of the shade fabric and the tube.

5. The method of claim 4, further comprising determining the deflection of the tube by modeling the weight of the shade fabric as a uniformly distributed load.

6. The method of claim 4, further comprising determining the deflection of the tube by modeling the weight of the shade fabric as a point load applied at a center of the tube.

7. The method of claim 4, further comprising determining the deflection of the tube by modeling the weight of the shade fabric as a plurality of point loads.

8. The method of claim 1, wherein attaching the shade fabric to the tube at the first edge portion of the shade fabric comprises welding the fabric to a spline.

9. The method of claim 8, further comprising cutting the first edge portion of the shade fabric in accordance with the deflection curve of the tube before welding the fabric to the spline.

10. The method of claim 1, wherein attaching the shade fabric to the tube at the first edge portion of the shade fabric comprises welding the fabric with a welded pocket.

11. The method of claim 10, further comprising cutting the first edge portion of the shade fabric in accordance with the deflection curve of the tube before welding the first edge portion of the shade fabric to form a spline pocket.
